(19) United States
(12) Patent Application Publication
(10) Pub. No.: US 2014/0123751 A1
(43) Pub. Date: May 8, 2014

(54) APPARATUS AND METHOD FOR MEASURING VELOCITY AND VOID FRACTION IN GAS-LIQUID TWO-PHASE FLOWS

(71) Applicant: Ming Lu, Tianjin (CN)

(72) Inventor: Ming Lu, Tianjin (CN)

(21) Appl. No.: 13/885,207

(22) PCT Filed: May 7, 2012
(86) PCT No.: PCT/CN12/75121

§ 371 Date: May 14, 2013

(30) Foreign Application Priority Data
Jun. 25, 2011 (CN) 201110208471.8

(51) Int. Cl. G01F 1/00

(52) U.S. Cl. CPC G01F 1/00
USPC 73/195

(57) ABSTRACT

The purpose of the invention is to supply an apparatus and method for measuring the three-dimensional velocity and void fraction in gas-liquid two-phase flows. It mainly includes a measuring probe (1), four pressure sensors (18), three electrodes (3), a back-flushing system (19), a pressure-based electrode couple selection system (14), and a data acquisition and analysis system (28).

### TECHNICAL FIELD OF THE INVENTION

This invention is related to fluid flow measuring domain. Particularly, it is an apparatus and method for measuring three-dimensional velocity and void fraction in gas-liquid two-phase flows.

### BACKGROUND OF THE INVENTION

Gas-liquid two-phase flows are the very common phenomena in engineering applications, such as the flows in hydraulic turbines, oil supply pipes, etc. Analysis and design for such hydraulic structures needs the velocity, pressure, and concentration of each phase in two-phase flows. The measurement of velocity and void fraction gas-liquid in two-phase flows is an area of significant progress. Among some recent experimental techniques for velocity measurement one can mention the use of particle image velocimetry (PIV), laser Doppler velocimetry (LDV), hot-film anemometry, and double-tip optical probes, etc. In spite of all the progress reported, these methods were found to have their drawbacks. For example, PIV and ADV are limited to applications where the gas concentration is less than 5˜10%. The use of hot-film anemometry was found to raise difficult questions related with the calibration and interpretation of the measured signals. The double-tip conductivity probes and the double-tip fiber-optical probes may be used for the measurement of the magnitude of the velocity vector, provided its direction known beforehand, allowing a previous orientation of the probe with the flow direction. Another practical option that could be employed for measuring velocity and void fraction of two-phase flows is the use of pressure sensors in conjunction with conductivity probes, whose principle of application relies on an ensemble measuring probe combining the multi-hole probe for the flow velocity and direction with the electricity conductivity probe for gas concentration (void fraction). The current technology is used mainly for the two-dimensional flow measurements; while there are some limitations for the three dimensional cases due to the difficulty to build several measuring components into ensemble probe. Actually, the measuring will fail for an ensemble probe with over large testing volume, because it loses the spatial accuracy and disturb flow filed; while it will do also for one with very small testing volume, because the gas bubble can block up the very tiny pressure tubes.

As known to all, it needs an Apparatus and method, as the premise of spatial accuracy, for measuring the velocity and void fraction of the three-dimensional gas-liquid two phase flows existing in a large number of hydraulic machines, including hydraulic turbines.

### SUMMARY OF THE INVENTION

The purpose of the invention is to supply an apparatus and method for measuring the three-dimensional velocity and void fraction in gas-liquid two-phase flows. From the FIG. 1 to FIG. 9, one descript the structure and principle of this invention. The key components include a measuring probe (1), four pressure sensors (18), three electrodes (3), a back-flushing system (19), a pressure-based electrode couple selection system (14), and a data acquisition and analysis system (28). The measuring tip, as truncated-cone-shaped end of the measuring probe (1), is multi-hole-structured. Those holes include the pressure holes connecting with the pressure sensors (18) used to calculate the velocity magnitude and directions, and the electrode holes for installing the electrodes (3) used to do the gas void fraction (concentration). The back-flushing system (19) is used to prevent the presence of gas bubble in the tubes connected with the pressure sensors (18). The pressure-based electrode couple selection system (14) is used to choose two from the three electrodes (3) as an electrode couple based on the signals from the pressure sensors(18). The electrode couple gives the concentration in the value of voltage. The data acquisition and analysis system (28) is used to acquire and analyze the measuring data.

### Technical Scheme of the Invention

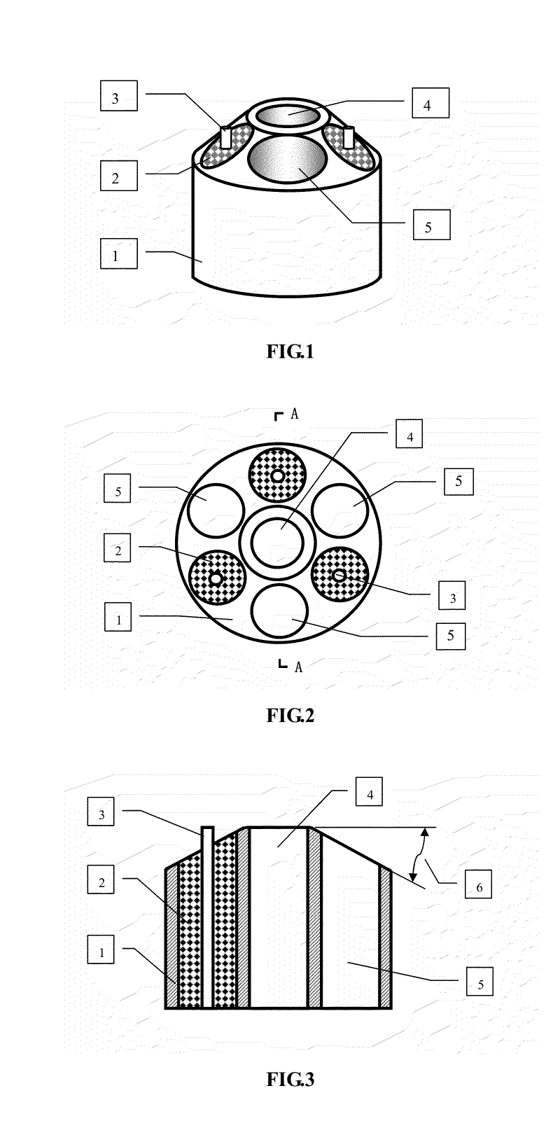

In detailed, The FIG. 1 as the stereo view of the measuring tip of the measuring probe. The FIG. 2 is the top view of the measuring tip of the measuring probe and the FIG. 3 is the sectional view of the FIG. 2. They show that this invention includes a measuring probe (1) with long-cylinder shape and truncated-cone-shaped end of 30˜40 degree taped angle (6). there is a central hole at the measuring tip along the rotational axis of the measuring probe and six periphery holes distributed evenly around the central hole. The central hole, also called the dynamic pressure hole (4), and the three 120 degree angle-spaced periphery holes called the static pressure holes (5) are the pressure holes; while the other three 120 degree angle-spaced periphery holes are the electrode holes. The central hole and the three other pressure holes are connected with the four pressure sensors (18) through the flexible or rigid connecting tubes. Three electrodes (3) are fixed in the electrode holes by the insulated plastic plugs (2) and connected with the pressure-based electrode couple selection system (14). The electrodes protrude from the electrode holes, but not exceeding the end-point of the measuring tip.

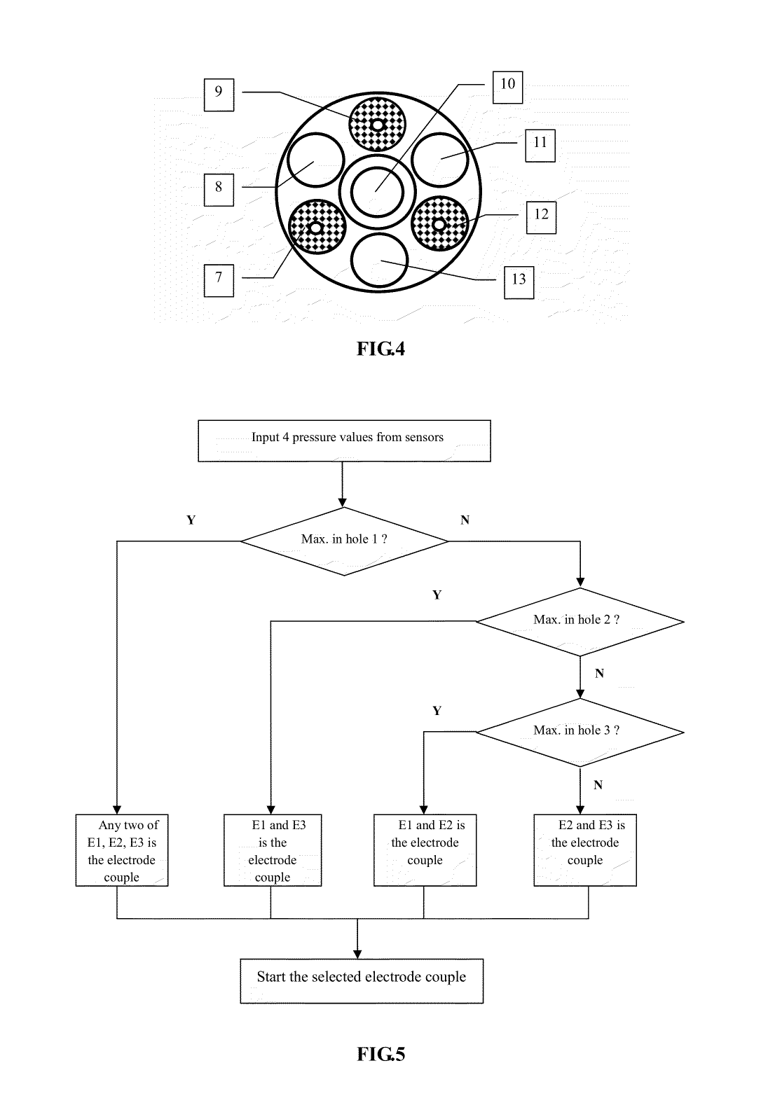

The FIG. 4 demonstrates the numbering scheme for the pressure and electrode holes of the measuring probe. It shows that the dynamic pressure hole (4) is numbered as 1 (10) and three static pressure holes (5) are numbered as 2 (13), 3 (8), and 4 (11), which sense different pressure for a specified velocity. The principle of application of the measuring probe on the velocity measurement is based on the pressure differentials between hole 1 (10) and hole 2 (13), 3 (8), and 4 (11), which is publicly known. The FIG. 4 also does the numbering scheme for the three electrode holes, which are E1(7), E2(9), and E3(12).

The pressure-based electrode couple selection system (14) connected with the three electrodes (3) is functioned to choose the usable electrode couple from the two electrodes closely near to any one static pressure hole (5) with the maximum pressure signal. The FIGS is the working flow chart of the pressure-based electrode couple selection system. For example, based on the flow chart, if a numbered static pressure hole 4 (11) has the maximum pressure, which means that the flow mainly impinge on this hole's area, the closely near electrode E1 (7) and E2 (9) are started as the electrode couple. If the dynamic hole (4), also the numbered hole 1 (10), has the maximum pressure, which means that the flow mainly comes orient to the probe axis, two of three electrodes (3) randomly are started as the electrode couple.

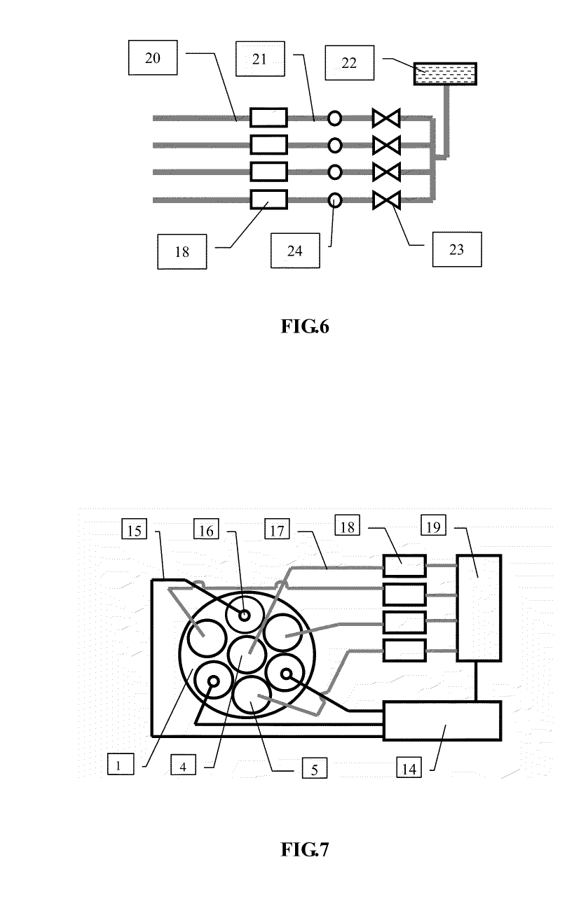

Four pressure holes need to connect with four pressure sensors (18) through flexible or rigid connecting tubs. Since the pressure holes and connecting tubes are generally very tiny, they are easy to be blocked by the gas bubbles in the two-phase flows because the gas bubbles may aggregate or adhere on the wall of the holes and tubes if the gas concentration in the two-phase flows is too high, which makes the measurement failed. To solve this problem, this invention use the back-flushing system (19) for pressure sensors, whose principle is shown in the FIG. 6. One end of four connecting tubes (20) is connected with four pressures (18) and the other end connected with four back-flushing tubes (21), then with four flow meters (24), four controlling valves (23), and a liquid head (22). The pressure inside the back-flushing tubes (21) are adjusted by the flow meters (24) and controlling valves (23), which makes the inside of the connecting tubes (20) filled of the liquid with known pressure to build back pressure to prevent any gas bubble entering the connecting tubes (20). When four pressure sensors (18) present the differential between the dynamic or static and the back pressure, the back-flushing system (19) improves the measurement reliability.

The measuring probe needs to be calibrated before it is used to measure the velocity magnitude, direction, and gas concentration (void fraction). In the calibration stage, it should build a data table presenting the relationship between the pressure coefficients from four pressure sensors (18) and the velocity magnitude, direction of three-dimensional flows, and presenting the one between the voltage values from three electrodes and the gas concentration. The calibration results are saved in the data acquisition and analysis system (28).

In measurement, the measuring probe (1) with the hole numbering scheme identical to that in the calibration stage is fixed in the gas-liquid two-phase flow field. Firstly, the data acquisition and analysis system (28) samples the pressure signals from four pressure sensors (18) transferred from the dynamic and static holes (4,5). Then, the pressure-based electrode couple selection system (14) is started to choose the electrode couple based on the received pressure and hole numbers, and outputs the voltage value of the selected electrode couple. All the pressures and voltage values are sent to the data acquisition and analysis system (28) to do the interpolation operation to the data table calibrated before. Finally, the three-dimensional velocity and void fraction (gas concentration) are obtained.

### Advantages of the Invention

This apparatus and method can obtain the three-dimensional velocity and void fraction (gas concentration) in gas-liquid two-phase flows at the same time. This invented measuring apparatus and method keeps highly precise spatially, little intrusive to flow field, simple structures and wide measuring range, which is good for the measurement of two-phase flows in some hydraulic machines, such as hydraulic turbines and oil pipes.

### BRIEF DESCRIPTION OF THE DRAWINGS

The FIG. 1 is the stereo view of the measuring tip of the measuring probe.

The FIG. 2 is the top view of the measuring tip of the measuring probe.

The FIG. 3 is the sectional A_A view of the FIG. 2.

The FIG. 4 is the numbering scheme for the pressure and electrode holes of the measuring probe.

The FIG. 5 is the working flow chart of the pressure-based electrode couple selection system.

The FIG. 6 is the principle of the back-flushing system.

The FIG. 7 is the application scheme of an apparatus and method for measuring three-dimensional velocity and void fraction in air-water two-phase flows.

The FIG. 8 is the sketch of calibration rig for the measuring probe.

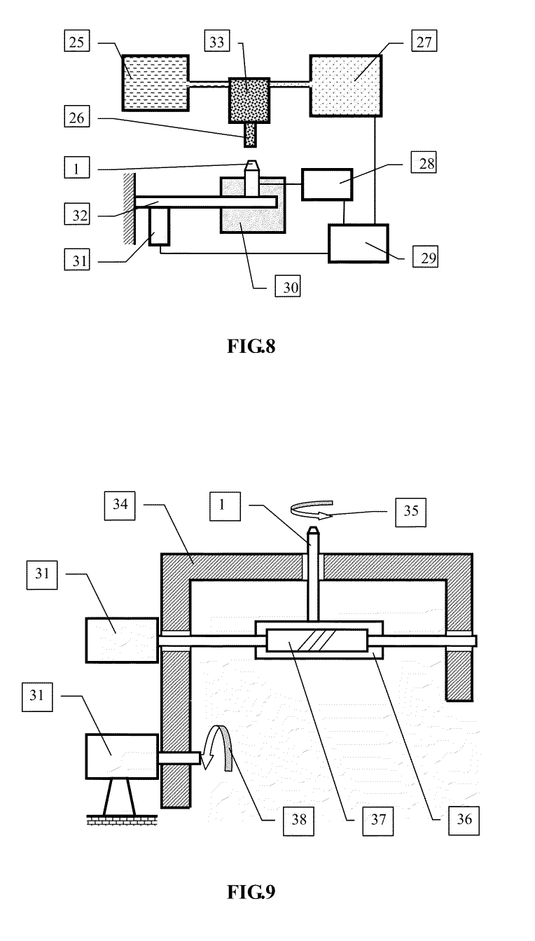

The FIG. 9 is the structure of the bracket system of the calibration rig with two degree of freedom.

### DETAILED DESCRIPTION OF THE PREFERRED EMBODIMENT

An embodiment according to the invention is illustrated following. It is an apparatus and method for measuring three-dimensional velocity and void fraction in air-water two-phase flows, whose application scheme shown in the FIG. 7. It includes a stainless steel made measuring probe (1) with long-cylinder-shape and truncated-cone-shaped end of 30 degree taped angle, whose shape is identical to that shown in the FIG. 1. There is a central hole at the measuring tip along the rotational axis of the measuring probe and six periphery holes distributed evenly around the central hole. The central hole, also called the dynamic pressure hole (4), and the three 120 degree angle-spaced periphery holes called the static pressure hole (5) are the pressure holes; while the other three 120 degree angle-spaced periphery holes are the electrode holes. All the holes' diameter is 0.8 to 1.0 millimeter and the probe tip's diameter is 5 millimeter, which means that the measuring spatial precision keeps 5 millimeter and the air-water two-phase flows are homogenous within this volume. This structure limits the distance of center of any two electrode holes smaller than 3 millimeter. The FIG. 2 and FIG. 3 also show the top view of the measuring tip of the measuring probe and its sectional view of the embodiment. In the FIG. 3, the taped angle (6) of the truncated-cone is 30 degree. This angle should be big enough to keep obvious pressure differential between the dynamic hole and static holes; while be small enough to reduce the measuring tip volume for the measuring spatial precision.

Assembling the pressure sensors into the measuring probe surely enlarges the measuring probe volume; meanwhile, the pressure damping in flexible tube connecting sensors apart makes pressure signal weak. In this embodiment, the tiny stainless steel rigid connecting tubes (17) are applied to connect the pressure sensors and pressure holes. However, because the pressure holes and connecting tubes are generally very tiny(0.8-1.0 millimeter diameter), they are easy to be blocked by the air bubbles in the two-phase flows because the air bubbles may aggregate or adhere on the wall of the holes and tubes if the air concentration in the two-phase flows is too high, which makes the measurement failed. To solve this problem, this embodiment uses the back-flushing system (19) for pressure sensors (18), whose principle is shown in FIG. 6. One end of four connecting tubes (17) is connected with four pressures (18) and the other end connected with four back-flushing tubes (21), then with four flow meters (24), controlling valves (23), and a liquid head (22). The pressure inside the back-flushing tubes (21) are adjusted by the flow meters (24) and four controlling valves (23), which makes the inside of the connecting tubes (17) filled of the water with known pressure to build back pressure to prevent any air bubble entering the connecting tubes. Four pressure sensors (18) present the obvious differential between the dynamic or static and the back pressure, which infer to the three-dimensional velocity of the air-water two-phase flows.

The numbering scheme for the pressure and electrode holes of the measuring probe in the embodiment is identical to that shown in the FIG. 4.

Three platinum made electrodes (16) with 0.4 millimeter diameter are fixed in the electrode holes as shown in the FIG. 1, 2, 3. The numbering scheme for three platinum electrodes (16) is also illustrated in the FIG. 4. The electrodes (16) protrude from the electrode holes, but not exceeding the end-point of the measuring tip. They can locally contact the fluid passing by from any direction and their output voltage changes when the air in air-water two-phase flows is there. The other ends of the electrodes are connected with the pressure-based electrode couple selection system (14) by the wire (15), which functions to choose the usable electrode couple from the two electrodes closely near to one static pressure hole with the maximum pressure signal. The FIGS is the working flow chart of the pressure-based electrode couple selection system (14).

The measuring probe (1) needs to be calibrated before it is used to measure the velocity magnitude, direction, and air concentration (void fraction). In the calibration stage, it should build a data table presenting the relationship between the pressure coefficients from four pressure sensors (18) and the velocity magnitude, direction of three-dimensional flows, which is in form of data table with the pressure values and α° (the angle around the central axial of the measuring probe) and β° (the angle perpendicular to the central axial), and presenting the one between the voltage values from three electrodes and the air concentration, which is in form of one with three curves of relationship of the output voltage values of E1 and E2, E2 and E3, and E1 and E4 with air concentration (from 5% to 80%). The calibration results are saved in the data acquisition and analysis system.

The FIG. 8 illustrates the sketch of calibration rig for the measuring probe of the invention. The FIG. 9 introduces the structure of the bracket system (32) of the calibration rig with two degree of freedom, It shows that a water supply system (25) (including the tube connected water pump and water throttle valves) transports the water into the air-water mixture (33). A air supply system (27) (including the tube connected air pump, air throttle valves, air flow meter, temperature meter) transports the air into the air-water mixture (33). The concentration of the air coming into the mixture (33) can be adjusted as 0 (pure water) to 100% (pure air). The homogeneous air-water two-phase flows can be made inside the air-water mixture (33) and flows out from the nozzle (26) at the bottom. The nozzle (26) points downwards and is aligned to the measuring probe (1) to be calibrated. Their distance is 22 millimeter. It is short enough to avoid the water reflection and the dynamic pressure change and long enough to avoid the mixing of the air in environment into the output air-water two-phase flows.

The two degree of freedom means α° (the angle around the central axial of the measuring probe) (35) and β° (the angle around the axial perpendicular to the central axial of the measuring probe) (38). The rotating of the bracket (34) is operated through the bevel gear (36) and the worm gear (37) controlled by the two steeping motors (31). The measuring probe (1) is installed on a bracket (34) with two degree of freedom. Its tip keeps upwards and is aligned to the nozzle (26). The part of the bracket with the measuring probe (1) is located inside a calibration cabin(30); while other part with steeping motors is done outside to avoid water bathing.

At the beginning of calibration, the bracket (34) controlled by the steeping motors (31) rotates the measuring probe (1) connected with pressure sensors (33) in directions α° (35) and β° (38) from −20° to +20°. In every angle, the calibration data acquisition and analysis system (28) and the computer (29) record the pressure signals from four pressure sensors (18) transferred from the dynamic and static holes (4,5), then adjust the air throttle valve to change the ratio of air to water and record the voltage values of any two electrodes combination from three. The data sampling frequency is 10 HZ and sampling time is 20 second.

After data processing, the data table with the pressure and α and β° is obtained and the one with three curves of relationship of the output voltage values of E1 and E2, E2 and E3, and E1 and E4 with air concentration (from 5% to 80%) is done also.

The data acquisition and analysis system runs in Lab View in windows XP environment. The hardware also includes the data amplifier, A/D transfer and data acquisition board. In every measuring point, the sampling time is long enough to make sure the data acquisition and analysis system conducts the pressure-based electrode couple selection system running

During measurement, the measuring probe is located along the main flow direction in the air-water two-phase flow field. Using the apparatus and method in this invention, one can obtain the three-dimensional velocity and void fraction (air concentration) in air-water two-phase flows at the same time.

1. An apparatus and method for measuring three-dimensional velocity and void fraction in gas-liquid two-phase flows includes a measuring probe (1), four pressure sensors (18), three electrodes (3), a back-flushing system (19), a pressure-based electrode couple selection system (14), and a data acquisition and analysis system (28).

2. An apparatus and method for measuring three-dimensional velocity and void fraction in gas-liquid two-phase flows wherein said measuring probe (1) has long-cylinder shape and a truncated-cone-shaped end as the measuring tip, on which there is a central hole along the rotational axis of the measuring probe (1) and six periphery holes distributed evenly around the central hole, among which the central hole and three 120 degree angle-spaced periphery holes, as the pressure holes, are connected with the four pressure sensors (18) through the flexible or rigid connecting tubes; while the other three 120 degree angle-spaced periphery holes, as the electrode holes, are for installation of three electrodes (3).

3. An apparatus and method for measuring three-dimensional velocity and void fraction in gas-liquid two-phase flows wherein said four pressure sensors (18) give the pressure signals to infer to the three-dimensional velocity and void fraction in gas-liquid two-phase flows.

4. An apparatus and method for measuring three-dimensional velocity and void fraction in gas-liquid two-phase flows wherein said back-flushing system (19) includes four connecting tubes (20), four back-flushing tubes (21), a liquid head (22), controlling valves (23), four flow meters (24), among which One end of the connecting tubes (20) is connected with four pressures (18) and the other end connected with four back-flushing tubes (21), then with four flow meters (24), four controlling valves (23), and a liquid head (22).

5. An apparatus and method for measuring three-dimensional velocity and void fraction in gas-liquid two-phase flows wherein said three electrodes (3) are fixed in the electrode holes by the insulated plastic plugs (2) and connected with the pressure-based electrode couple selection system (14) to measure gas void fraction (concentration).

6. An apparatus and method for measuring three-dimensional velocity and void fraction in gas-liquid two-phase flows wherein said a pressure-based electrode couple selection system (14) is connected with the three electrodes (3) choose the usable electrode couple from the two electrodes closely near to any one pressure hole with the maximum pressure signal.

7. An apparatus and method for measuring three-dimensional velocity and void fraction in gas-liquid two-phase flows wherein said measuring probe (1) needs to be calibrated to build a data table presenting the relationship between the pressure coefficients from four pressure sensors (18) and the velocity magnitude, direction of three-dimensional flows, and presenting the one between the voltage values from three electrodes and the gas concentration.

8. An apparatus and method for measuring three-dimensional velocity and void fraction in gas-liquid two-phase flows wherein said data acquisition and analysis system (28) saves calibration results of the measuring probe (1) and interpolation for the results need to do in measuring for the velocity magnitude, direction, and gas void fraction (concentration). in gas-liquid two-phase flows.
